(19) United States
(12) Patent Application Publication
(10) Pub. No.: US 2002/0184547 A1
(43) Pub. Date: Dec. 5, 2002

(54) Device and method for selectively powering down integrated circuit blocks within a system on chip

(75) Inventors: Russell Francis, Glos (GB); Michele Alia, Giarre (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I., Agrate Brianza (IT)

(21) Appl. No.: 10/008,586

(22) Filed: Nov. 5, 2001

(30) Foreign Application Priority Data
Nov. 3, 2000 (EP) 00830732.4

(51) Int. Cl. G06F 1/26; G06F 1/28; G06F 1/30

(52) U.S. Cl. 713/322

(57) ABSTRACT

A system-on-chip (SOC) includes a power down circuit. Within the SOC are several circuit blocks, each of them operating based upon a local clock signal. A system clock is coupled to each of the circuit blocks for providing a system clock signal thereto which functions as the local clock signal for selected circuit blocks. A power control manager provides a signal that at least partially determines whether the system clock signal will operate as the local clock signal for selected circuit blocks. The respective circuit blocks include a local power control circuit for selectively maintaining the system clock signal as the local clock signal after the local power control receives a signal from the power control manager to shutdown this circuit block if this circuit block is currently busy when the signal to shutdown is received.

### FIELD OF THE INVENTION

The present invention is directed to integrated circuits, and more particularly, to a power down circuit for reducing power consumption in a system-on-chip (SOC) comprising a plurality of circuit blocks by switching off the system clock to selected circuit blocks that are temporarily unnecessary.

### BACKGROUND OF THE INVENTION

Current trends in integrated circuit designs call for creating an entire manufactured circuit system on a single chip. Such a system is termed system-on-chip or SOC. This differs from simple circuit integration in that many different types of circuits can be included on a single chip. For example, an SOC could include a computer processor, various signal processors, a large amount of memory, various clocks, power down circuits, and necessary system controllers all integrated on a single piece of silicon or integrated into a single package. This level of integration was not previously possible with prior integration techniques, and is very advantageous because useful devices can be created in very small sizes.

FIG. 1 is a block diagram showing an SOC 10a. The SOC 10a is formed of a number of different integrated circuit portions (IPs) or blocks 12, 14, . . . , 20. Each IP block 12-20 is connected to a system clock 30. The system clock 30 distributes a system clock signal to each of the IP blocks 12-20.

Important examples of devices that can include SOCs are cellular phones, palmtops, notebooks, computer components, movable equipment, communication apparatuses, biomedical apparatuses, digital cameras, MP3 players, etc. Such applications generally require a battery or some sort of power supply, which typically presents cost, duration, weight and dimension issues. To increase the longevity of the power supplies for these devices, and especially for portable devices which require a portable power source, power consumption of the SOCs must be reduced from their current levels.

Dynamic power consumption of the different circuits blocks 12-20 integrated on a single SOC 10a is given by the formula P=f*C*v* 2, where P is power, f is operating frequency of a circuit block, C is capacitance of all of the gates of the circuit block, and v is the power supply voltage. Therefore, in addition to reducing the power supply voltage and the overall capacitance, power of the SOC 10a may be conserved by reducing the operating frequency of the different circuit blocks 12-20. One way to implement this is to temporarily switch off the system clock for some of the IP blocks 12-20 of the SOC 10a that are not necessary for immediate functions. Because not all of the IP blocks 12-20 necessarily operate at the same time in the SOC 10a, some of them are unused and are eligible to be shutdown.

FIG. 2 shows an SOC 10b that is similar to the SOC 10a of FIG. 1, but additionally includes a power control manager 40. The power control manager 40 controls a bank of switches 42 that are coupled between the system clock 30 and the various IP blocks 12-20. When the power control manager 40 determines that particular IP blocks should be shutdown, such as circuit blocks 14 and 16, for example, a signal is generated and fed to the bank of switches 42. The bank of switches 42 then controls the particular switch coupled to the selected IP blocks, in this example IP blocks 14 and 16, and disconnects them from the system clock 30. When the selected IP blocks 14, 16 do not receive the system clock 30, they stop functioning and, based upon the above equation, do not draw any power because the operating frequency of the circuit is brought to zero.

Although the idea of separating the system clock from the various IP blocks is compelling, most SOCs cannot be controlled in such a manner. The implementation of such a system as shown in FIG. 2 causes problems. As described above, many different types of IP blocks are contained within a particular SOC, and each of these IP blocks have unique requirements for when they can be safely shutdown.

It can therefore be difficult to establish an exact time when it is possible to switch off the clock to an IP block without causing errors. In some cases, if the clock to the IP block is stopped abruptly, there is a risk of preventing a critical operation of the block from being carried out. For example, an IP block could be performing a necessary communication protocol and the shutdown of the block could cause the SOC to disregard the protocol. Examples of protocols that could easily be disregarded include memory-DMA, and master-slave blocks among others. Additionally, removing a system clock from a counter or a timing signal generator could be fatal to that particular IP block.

Some of these problems are illustrated in FIG. 3, which shows an SOC 10c that has prevented the system clock 30 from reaching the IP blocks 14, 16 and 18, while continuing to supply the IP blocks 12 and 20. In each of the cases of the non-supplied blocks 14, 16, 18, there are potential problems. For instance, the IP block 14 may be in the middle of a memory-DMA protocol operation with a memory unit 24, and its abrupt halt may violate that protocol. Similarly, the IP block 16 may be communicating with a slave peripheral 26, and an abrupt halt may cause a malfunction or protocol violation. Additionally, the IP block 18 may include counters which rely on the system clock 30 for accuracy. Separating the system clock 30 from the IP block 18 could seriously degrade such accuracy.

### SUMMARY OF THE INVENTION

In view of the foregoing background, an object of the invention is to accurately control the shutdown of multiple and different types of circuits blocks that are integrated into a single system to preserve the necessary function of the circuit blocks.

This and other objects, advantages and features according to the invention are provided by switching off the system clock for portions of the circuit blocks that are temporarily unnecessary. Specifically, this invention involves a power down circuit for use in a system-on-chip comprising a plurality of circuit blocks each operating based upon a local clock signal. A system clock is coupled to one or more of the circuit blocks and provides a system clock signal that functions as the local clock signal of selected ones of the plurality of circuit blocks. A power control manager is coupled to the plurality of circuit blocks and provides a signal that at least partially determines whether the respective system clock signals will function as the local clock signals for the corresponding plurality of circuit blocks.

More particularly, a check is performed to see if the circuit blocks that are desired to be shutdown are currently operating or currently idle. If the circuit blocks desired to be shutdown are currently idle, the system clock is immediately separated from the local clock of the applicable circuit block, and the local clock signal is shutdown. If, however, the circuit block is currently busy, the power manager will not separate the system clock from the local clock, and will instead wait until the circuit block enters the idle state.

Based on this idea, this invention provides a selective power down circuit as previously indicated and defined in the characterizing portion of claim 1.

Additionally, this invention provides a method for powering down individual circuit blocks within a system-on-chip as previously indicated and defined in the characterizing portion of claim 7.

### BRIEF DESCRIPTION OF THE DRAWINGS

The features and advantages of the apparatus and method to power down selected circuit blocks within a system-on-chip according to the invention will be apparent by reading the following description of a preferred embodiment thereof, given by way of non-limiting examples with reference to the accompanying drawings:

FIG. 1 is a block diagram of a system-on-chip according to the prior art;

FIG. 2 is a block diagram of a system-on-chip that includes a power control management circuit according to the prior art;

FIG. 3 is a block diagram of a system-on-chip highlighting the problems associated with the power control management circuit illustrated in FIG. 2;

FIG. 4 is a block diagram of a system-on-chip according to the invention;

FIG. 5 is a flow diagram showing implementation of the local power control according to the invention;

FIG. 6 is a psuedocode listing describing operation of the flow diagram illustrated in FIG. 5;

FIG. 7 is a schematic diagram of a logic circuit for implementing a local power control according to the invention;

FIG. 8 is a timing diagram showing the interaction of several signals within the system-on-chip according to the invention; and

FIG. 9 is a block diagram showing implementation of a local power control for a complete system-on-chip according to the invention.

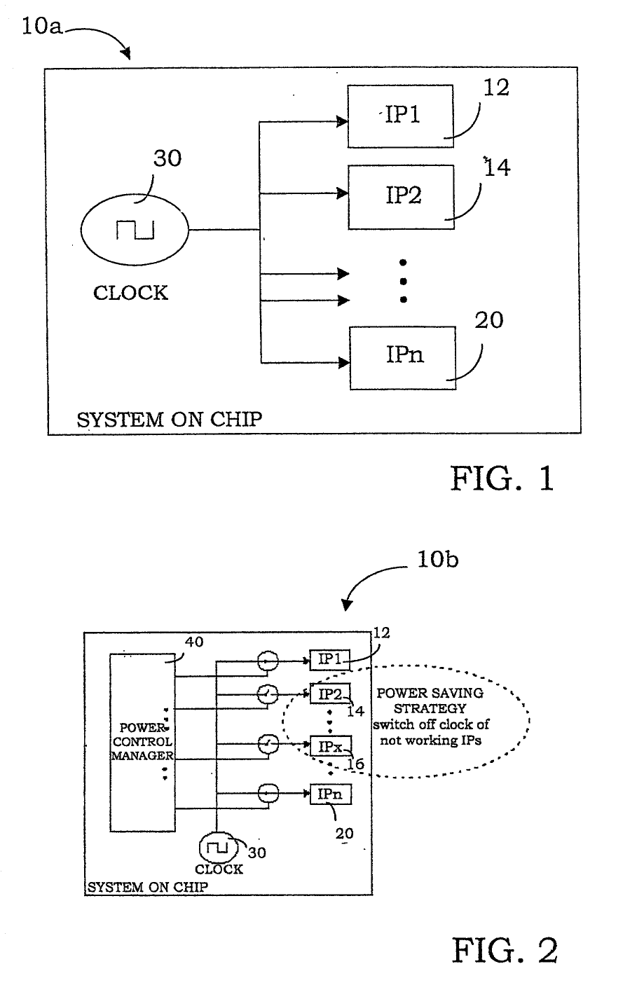

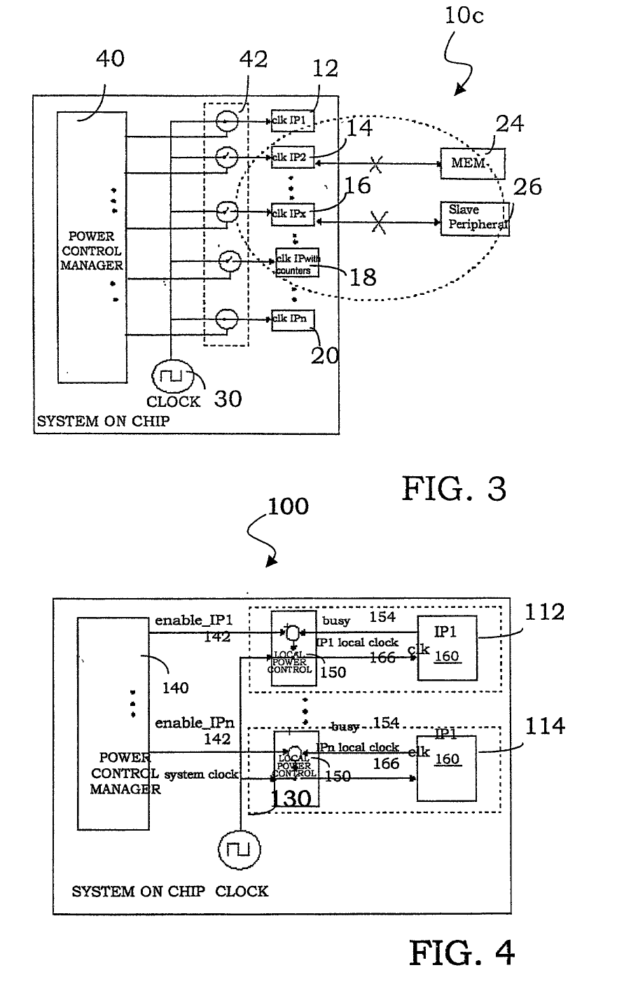

### DETAILED DESCRIPTION OF THE PREFERRED EMBODIMENTS

FIG. 4 illustrates interconnections that may be used to implement the invention. Shown is an SOC 100 including a system clock 130, a power control manager 140, and two IP blocks 112 and 114. Within the IP blocks 112, 114 are a local power control 150 and block circuitry 160, and lines for connecting them as will be described in greater detail below.

The system clock 130 is provided to the local power control 150 of each of the IP blocks 112, 114. Additionally, a clock enable line 142 couples each local power control 150 to the power control manager 140. Each local power control 150 has its own clock enable line 142 coupled to the power control manager 140. Of course any number of IP blocks having local power control could be included in the SOC 100, with only the addition of the required number of clock enable lines 142 and the proper connections to the system clock 130 being required. The discussion below will be directed toward a single IP block 112, but represents operation of all of the IP blocks 112, 114, etc., within the SOC 100.

Each local power control 150 receives three signals. The signals received by the power control 150 are from the clock enable line 142, from the system clock 130, from the block circuitry 160 via a busy line 154 for providing a “busy” signal. The busy signal is generated by the block logic 160 of the respective IP block 112, and is provided to the corresponding local power control 150. The signal on the busy line 154 will indicate to the local power control 150 whether the block logic 160 is in an “idle” or a “processing” state. In this case, a 1 will indicate that the block logic 160 is processing, and a 0 will indicate that the block logic is currently idle. Based upon the logic states of the three signals received by the local power control 150, the local power control generates a signal. The signal generated by the local power control 150 is a local clock 166. Each of the IP blocks 112, 114 will have one local clock 166 generated by its local power control 150, which provides the clock signal to the respective IP block so that the block logic 160 will operate. If there is no clock signal on the local clock 166, the block logic 160 will not operate. In this way, the SOC 100 can selectively disconnect the IP blocks 112, 114 that are not necessary for present functions of the SOC. Doing this lowers overall power consumed by the SOC 100, because an IP block 112 does not draw any power if it does not have a local clock signal.

In operation, the local power control 150 for the IP block 112 receives a clock enable signal on the clock enable line 142. A signal of either a 0 or a 1 is always present on this enable line 142. Normally, this signal will be a 1 when the IP block 112 is to be provided the clock signal 130 as the local clock signal 166, and will be a 0 when the IP block is not to receive the local clock signal, if possible. These signals could be reversed, of course, with a necessary change in the circuitry that implements the local power control 150, and such a change is within the scope of one skilled in the art. For purposes of this description, a 1 signal on the clock enable line 142 will indicate that the IP block 112 should be operating normally, and a 0 signal on the clock enable line 142 will indicate that the IP block 112 should be shutdown, if possible.

When the power control manager 140 determines that the IP block 112 should be shutdown, it puts a 0 signal on the clock enable line 142 that is coupled to the local power control 150. The local power control 150 will then determine which state, busy or idle, that the block logic 160 is in. If the block logic is currently idle, the local power control immediately separates the system clock signal 130 from the local clock signal 166, and thereby prevents the IP block 112 from having a local clock signal. As discussed above, the IP block 112 cannot operate and does not draw any power without a local clock signal.

If instead, the block logic 160 is currently busy, the local power control 150 continues to provide the system clock signal 130 as the local clock 166, thereby allowing the block logic to continue any operations. Once the block logic 160 has completed its operations and puts an idle signal 0 on the busy line 154, the local power control 150 will then disconnect the system clock signal 130 and effectively shutdown the IP block 112. This is as long as the shutdown signal 0 remains on the clock enable line 142.

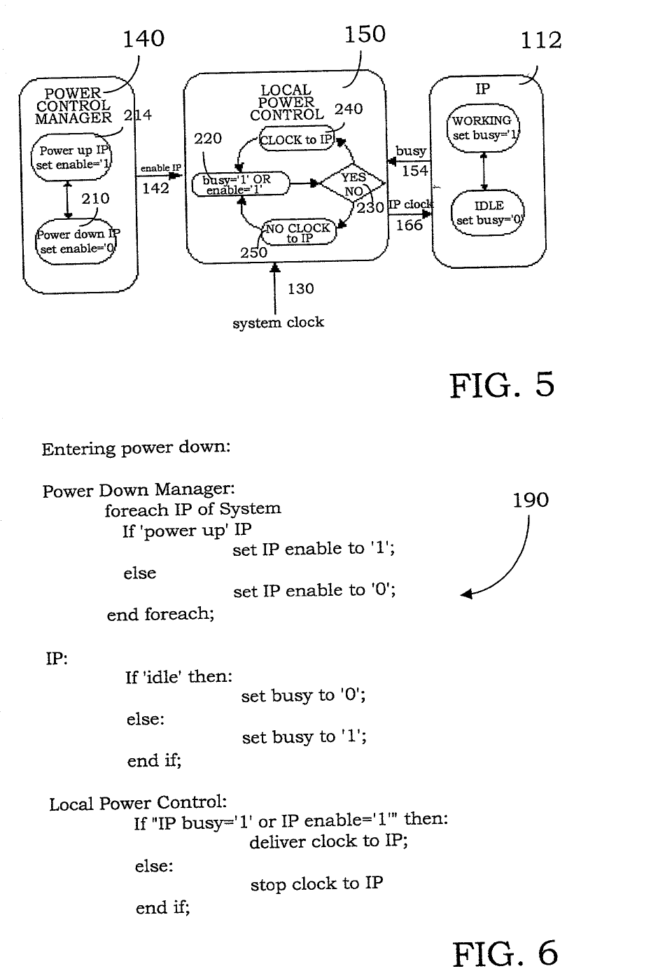

FIGS. 5 and 6 illustrate a flowchart and psuedocode, respectively, explaining the operation of an implementation of the invention. In FIG. 5, if the power control manager 140 desires the IP block 112 to stop drawing power, it generates a 0 on the clock enable line 142 in step 210, otherwise it generates a 1 in step 214. The local power control 150 receives this signal from the clock enable line 142 at step 220 and performs a check in step 230. The check 230 determines if either the signal sent from the power control manager 140 on the clock enable line 142 or the signal on the busy line 154 is a 1. A 1 signal on the clock enable line 142 indicates that the power control manager 140 desires the IP block 112 to remain operating, and a 1 signal on the busy line 154 indicates that the block logic 160 of the IP block 112 is in fact operating. If either of these conditions are true, the local power control 150 will pass the system clock 130 to the IP block 112 as its local clock 166 in step 240.

If neither of these conditions are true, meaning that the power control manager 140 desires that the IP block 112 be shutdown (0 on the clock enable line 142) and the block logic 160 of the IP block 112 is in fact idle (0 on the busy line 154), then the local power control 150 separates the system clock 130 from the local clock 166. In other words, a clock signal is not provided as the local clock signal 166. Pseudocode 190 of FIG. 6 explains the above paragraph.

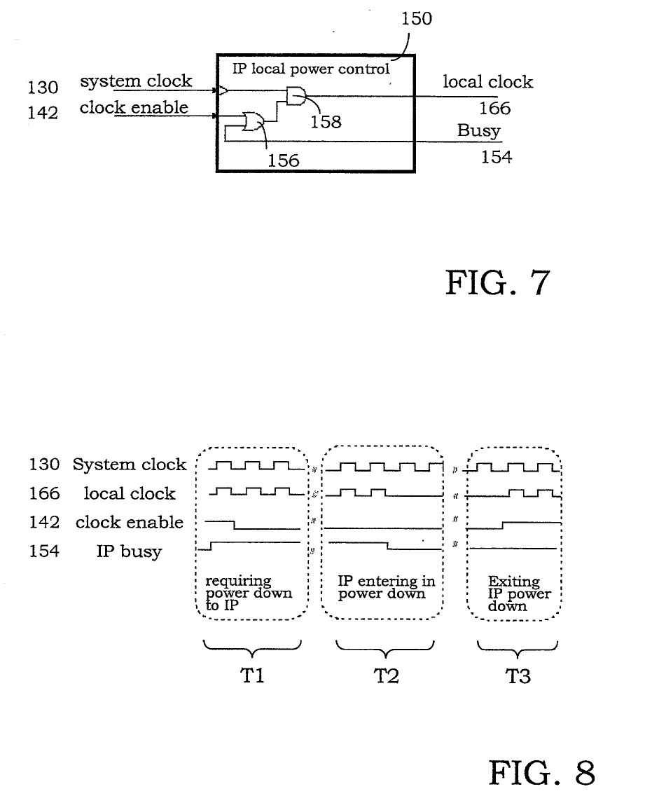

FIG. 7 shows a block diagram of an example local power control 150. Included within the local power control 150 is a set of logic gates 156 and 158. In this particular embodiment of the local power control 150, the logic gate 156 is an OR gate and the logic gate 158 is an AND gate, although any combination of logic gates that produce the correct result is acceptable for the local power control, and is within the scope of the invention.

In FIG. 7, the OR gate 156 has a first input connected to the clock enable line 142 and a second input connected to the busy line 154. An output signal from the OR gate 156 is a first input to the AND gate 158, with the system clock 130 being a second input. The output of the AND gate 158 is the local clock signal 166, which is provided to the block logic 160 of the IP 112 (not shown in FIG. 7). As illustrated in FIG. 7, the local clock 166 will have the same frequency as the system clock 130, but will only be present when the output signal from the OR gate 156 is a 1 signal. Therefore, if either the clock enable signal 142 or the busy signal 154 is a 1, the system clock 130 is passed as the local clock 166, otherwise, no clock signal is passed.

Examples of signals feeding the local power control 150 are shown in FIG. 8 for three different time periods t1, t2 and t3. In all of the time periods t1, t2 and t3, the system clock 130 continues to operate at the system frequency. In a first time period t1, the signal on the busy line 154 changes from a 0 to a 1. This indicates that the IP block 112 is currently performing operations and must have a clock provided to it. Shortly after the busy line 154 changes, the clock enable line 142 changes from a 1 to a 0. This indicates that the power management system 140 of FIG. 4 desires the IP block 112 to shutdown. However, because the busy line 154 is still a 1, the local power control 150 continues to provide the system clock 130 as the local clock 166.

In the period t2, the IP block 112 completes its current work and lowers the busy line 154 from a 1 to a 0. Once this occurs, because both the busy line 154 and the clock enable line 142 are a 0, the output of the OR gate 156 (FIG. 7) goes LOW, and therefore the output of the AND gate 158 also goes LOW. This causes the local clock 166 to stop, and the IP block 112 goes into a powered down mode and does not draw any power.

In the period t3, the clock enable line 142 changes from a 0 to a 1, indicating that the power control block 140 will allow the IP block 112 to restart its operations. When the signal on the clock enable line 142 changes from a 0 to a 1, the output of the OR gate 156 immediately (after a negligible propagation delay) changes from a 0 to a 1. This in turn causes the AND gate 158 to again pass the system clock 130 as its output for the local clock 166, which is again fed to the IP block 112. Once the local clock 166 is present at the block logic 160 of the IP block 112, the block logic can resume operations when needed.

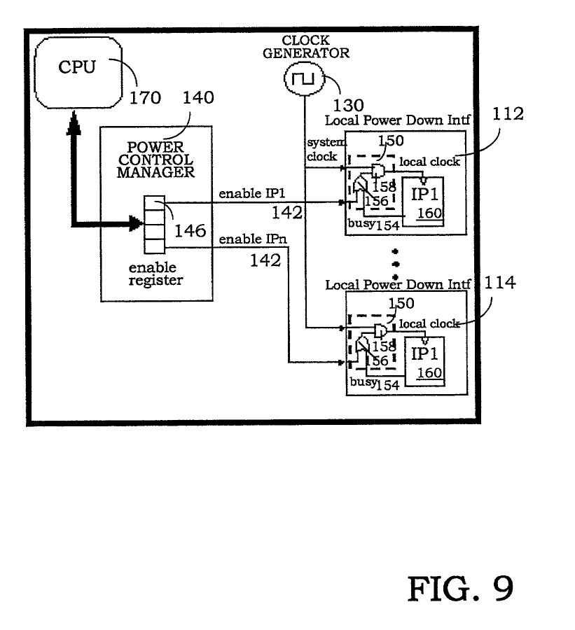

FIG. 9 shows a top level architecture implementation of an SOC embodying the invention. An SOC 300 includes IP blocks 112 and 114. Again, any number of IP blocks could be present within the SOC 300, and only two are shown for purposes of illustration. The system clock 130 is always in operation within the SOC 300, and is distributed as a first input to the AND gate 158 within the local power control 150 contained in each of the IP blocks 112, 114. Another input to the AND gate 158 is the output from the OR gate 156, which has a first input from the clock enable line 142 and a second input from the busy line 154. When either the signals on the clock request line 142 or the busy line 154 are a 1, the system clock 130 is passed to the local clock 166 to drive the block logic 160. Otherwise, when neither of the signals are a 1, no clock signal is passed as the local clock 166.

The power control manager 140 may include a register 146 that contains a memory storage location for each IP block 112, 114 within the SOC 300. The register 146 is coupled to all of the clock enable lines 142 in the SOC 300. That is, each of the clock enable lines 142 will have a 0 or a 1 signal on it determined by the data stored in the respective memory location of the register 146. Providing data on a signal line, such as the clock enable line 142 to match data stored in a memory location, and reading data from a signal line and storing it in a memory location are conventionally known.

In one embodiment, a CPU 170 can write data into the particular memory location of the register 146 for a particular IP block within the SOC 300, and the clock enable line 142 will be changed accordingly. In another embodiment, the CPU 170 would not be allowed to write data into the register 146, but could only read data already written there by the power control manager 140. In still another embodiment, programmable control could be given where the power control manager 140 or the CPU 170, or both, would be selected to write data into the register 146, thereby controlling the shutdown of the respective IP block.

By storing the data on the state of the clock enable line in the register 146, the CPU 170 can check via software the current states of the IP blocks 112, 114 in the SOC 300 by reading the data stored in the particular locations of the register 146. If the data indicated that the clock enable line 142 of a particular IP block 112, 114 was a 1, the CPU 170 would know that the IP block was provided the system clock 130 as its local clock 166. If the data indicated that the clock enable line was a 0, the CPU 170 would know that the IP block is either in the shutdown state, or completing its necessary operations before shutting down.

If a second register (not shown in FIG. 9) would be used to store the status of each busy line 154, in a similar manner for storing the state of the clock enable line 142, the CPU 170 would exactly know the state of the IP block by comparing signals read from the first and second registers to Table 1 as shown below.

TABLE 1

| First Reg. | Second Reg. | State of IP block |
|---|---|---|
| 0 | 0 | Shutdown |
| 0 | 1 | Busy, but will shutdown at |
| | | completion |
| 1 | 0 | Enabled (clock provided) |
| | | but not busy |
| 1 | 1 | Enabled and busy |

This invention provides a straightforward and convenient way to safely switch off the clock to desired circuits within a system-on-chip by providing a signal to the desired circuits and letting them finish their processing prior to being shut down. The implementation described above provides a further benefit in that control of such shutdowns can be executed by hardware and/or by software.

That which is claimed is:

1. A power down circuit for use in a System on Chip SOC, comprising:
a plurality of circuit blocks (112, 114) in said SOC, each of said circuit blocks having a local clock (166);
a system clock (130) coupled to one or more of said plurality of circuit blocks (112, 114) and structured to act as said local clock (166) of selected ones of said plurality of circuit blocks;
a power control manager coupled to one of said plurality of circuit blocks (112, 114) and structured to provide a signal at least partially determining whether said system clock (130) will act as said local clock (166) of said one of the circuit blocks; characterized in that, in said one of the circuit blocks (112, 114) contains a local power control (150) structured to selectively maintain the system clock (130) acting as said local clock (166) said block after said local power control (150) receives a signal to shutdown (142) said block from said power control manager (140), if said block is busy when said signal to shutdown said block is received.

2. A power down circuit for use in the System on Chip SOC according to claim 1, further characterized in that said local power control (150) is a clock separation circuit coupled to the power control manager (140) and structured to prevent said system clock (130) from acting as said local clock (166) in said block that is receiving said shutdown signal (142) while in an idle state.

3. A power down circuit for use in the System on Chip SOC according to claim 1, further characterized in that said power control module (140) is coupled to said local power control (150) through a clock enable line (142).

4. A power down circuit for use in the System on Chip SOC according to claim 3, further characterized in that said local power control (150) includes a logic circuit (156, 158) coupled to said clock enable line (142), a busy line (154), and said system clock (130), and said logic circuit is structured to generate said local clock (166) at an output of said logic circuit (156, 158) responsive to signals on said clock enable line (142), said busy line (154), and said system clock (130).

5. A power down circuit for use in the System on Chip SOC according to claim 1, further characterized in that said power control module (140) comprises a register (146) coupled to a clock enable line (142) of each of said circuit blocks (112, 114), and in that said register (146) stores a datum indicating a state of one or more of the clock enable lines (142) respectively coupled to it.

6. A power down circuit for use in the System on Chip SOC according to claim 5, characterized in that it further comprises a CPU coupled to said power control module (140), the CPU able to determine said states of said circuit blocks (112, 114 by querying said register (146).

7. A power down circuit for use in the System on Chip SOC according to claim 1, characterized in that more than one system clocks are present in said System on Chip and are respectively structured to act as said local clock (166) of selected ones of said plurality of circuit blocks.

8. A method of powering down individual circuit blocks of a plurality of circuit blocks within a System on Chip, comprising the steps of:
generating a system clock signal (130) that is coupled to said plurality of circuit blocks (112, 114) and can be used as a local clock (166) for said plurality of circuit blocks;
generating a signal to power down (142) selected of the plurality of circuit blocks;
transmitting said signal to power down (142) said selected circuit blocks to a local power control (150); characterized in that the method further comprises:
accepting said signal to power down (142) at said local power control (150) in each of said selected circuit blocks (112, 114);
accepting a current state of said respective circuit block on a busy line (154); and
shutting down said selected circuit blocks after comparing both said signal to power down and said current state of said respective circuit block.

9. A method of powering down individual circuit blocks according to claim 8, characterized in that said method further comprises preventing said shutdown of said selected circuit blocks if either said signal to power down is not received, or if said selected circuit blocks are currently busy.

10. A method of powering down individual circuit blocks according to claim 9, characterized in that shutting down said selected circuit blocks comprises preventing said system clock (130) from acting as said local clock (166) in said selected circuit blocks.

11. A method of powering down individual circuit blocks according to claim 10 characterized in that preventing said system clock (130) from acting as said local clock (166) comprises disconnecting said system clock (130) from said local clock (310) only when those circuit blocks that have received said signal to power down (142) selected circuit blocks are idle.
